(19) United States
(12) Patent Application Publication
(10) Pub. No.: US 2005/0257394 A1
(43) Pub. Date: Nov. 24, 2005

(54) Method and a device for drying a water-damaged building

(76) Inventor: Knut Claesson, Granna (SE)

Correspondence Address: SUGHRUE MION, PLLC, 2100 PENNSYLVANIA AVENUE, N.W., SUITE 800, WASHINGTON, DC, 20037, US

(21) Appl. No.: 10/486,945

(22) PCT Filed: Aug. 16, 2002
(86) PCT No.: PCT/SE02/01464

§ 371 Date: Feb. 13, 2004

(30) Foreign Application Priority Data
Aug. 17, 2001 (SE) 0102754-9

(51) Int. Cl. F26B 13/30

(52) U.S. Cl. 34/92

(57) ABSTRACT

In a method of drying a water-damaged building with the aid of drying plant (1) that includes a drying rotor (2) or some other other device which delivers dry air to the drying process, and a high-pressure turbine or a fan (3) for transportation of air, the turbine (3) is caused, alternatively, to press dry air into a water-damaged space (10a) in the building (10) or to suck moist air from such a space. In these operational modes, the turbine (3) co-acts with means, e.g. pipes (4, 5) and/or valve-equipped conduits (e.g. 7; 15) which facilitate switching between the two disparate operational modes. The invention also relates to drying plant that functions in accordance with the inventive method.

### FIELD OF INVENTION

The present invention relates to a method of drying a water-damaged building with the aid of drying plant that includes a rotor or some other means for delivering dry air to the drying process, and a high-pressure turbine or some type of fan or blower for the transportation of air.

The invention also relates to drying plant that functions in accordance with the inventive method.

A very typical building construction is a layered construction comprised of structural concrete and including a floor with insulation between the floor and the concrete.

A gap is located between the floor and the walls of the structure, i.e. the floor terminates short of the walls. This is necessary in order to prevent noise propagating from the floor to the walls and from there out into the building. The insulation prevents sound from passing through the floor to an underlying room or apartment.

One drawback with this type of construction is that, in the event of water damage, the water present on the floor will run down through the gap at respective walls and therewith onto the insulation, in other words the space between the structural concrete and the floor is filled successively with water.

### DESCRIPTION OF THE BACKGROUND ART

A typical method of drying this type of construction uses a high-pressure turbine or high-pressure fan which is connected to a hose system for sucking air through the insulation, wherewith room air is sucked down through the gap between floor and wall as a result of the sub-pressure created in the insulating layer, and through the insulating layer and thereafter delivered, laden with moisture, to the surroundings via the turbine or the fan

A water separator can be placed in the hose system upstream of the turbine, should the moist air sucked out from the insulation contain water.

Drying can be accelerated by also placing a dehumidifier in the room, so that the air sucked down through the gap will be as dry as possible. The drying process can be continued in this way, i.e. with the so-called suction method, until the construction is dry.

In the case of an alternative method, dry air is, instead, pressed or forced down into the insulation, which normally results in a more rapid drying process.

In this case, the dry air passes from a dehumidifier directly into the turbine/fan and from there down into the insulation, meaning that dry air is used where required.

The aforementioned methods with which separate dehumidifiers and high-pressure turbines or high-pressure fans are used, however, result in several of the following problems and drawbacks:
a) Many components that require supervision and service must be seen to or taken care of.
b) Installation of the systems is both difficult and time-consuming.
c) The devices used have a very high sound level.
d) The many different components required result in high purchasing and operating costs.
e) The plant used delivers energy to the surroundings, which delays the drying process.
f) The plant is difficult to control and regulate.

Thus, such plants require the use of a plurality of components, such as dehumidifiers, high-pressure fans, hoses, pipes, hose clips, etc., causing handling and installation of such plants a complicated process. The plants also take up a large amount of space, which is unnecessarily expensive and difficult to regulate in view of the many different components used.

Another problem that is not readily solved is connected with the high sound level of high-pressure turbines and high-pressure fans. This noise subjects those staying or living in a water-damaged area under treatment to a great deal of discomfort. In some instances, there is a requirement that the sound level shall not be allowed to exceed a given number of decibels, therewith rendering this type of drier unusable.

SE C2-502635 (Swedish Application No. 9500069-1) (Corroventa Avfuktning AB) teaches a method and an air-drying plant that solves some of the aforesaid problems.

This document thus teaches a method and a plant for enhancing the yield of an air-drying process in which the process air is delivered to a rotating drying rotor in a defining wall of a first process air chamber in an insulated building. The process air is dehumidified and dried by moisture exchange with heated regenerating air. The dried and heated process air is sucked into a second process air chamber that houses a high-pressure fan equipped with an electric motor. The pressurised process air of elevated temperature is then delivered directly to a water-damaged layer or area.

DE-A1-19914846 (Dörrie) describes a similar method, in which air that has been dried and heated by the rotor is delivered through a conduit to the inlet of the high-pressure fan.

These methods and devices can only be used when the water-damaged construction shall be dried by pressing dry air down into the water-damaged layer or strata. Although pressure drying provides a quicker result, there are many instances in practice where the suction method must be used, e.g.
1) if the pressure method is used when free water is present in the insulation, the water will be forced out into the construction instead of being removed from the insulation, as opposed to the result when using the suction method.
2) when using the pressure method, moist air will pass from the construction through the gap between floor and wall and out into the room, which may be suitable or permitted in certain cases.
3) if the insulation contains fibres, such as glass wool or mineral wool, these fibres are liable enter the room, which is forbidden in many instances.
4) when pressure drying and the moist air enters the room, foreign odours may be manifested during the first days of the drying process, which cannot be accepted at times.

When the construction cannot be dried by the pressure method, e.g. with the aid of the method described in the above-mentioned Swedish document, for the aforesaid reasons or for other reasons, it has hitherto been necessary to dismantle the existing plant and to install separate dehumidifiers, high-pressure fans, hoses, etc., for the purpose of thereafter sucking moisture from the construction. The following associated drawbacks are obvious:
a) Increased costs.
b) Longer drying times.
c) Greater installation work.
d) Higher investments in respect of substantially more components.

In addition, a plant that includes separate dehumidifiers, high-pressure fans, hoses, etc., will suffer all of the drawbacks described above.

### OBJECT OF THE INVENTION

Accordingly, a prime object of the invention is to provide a method and an arrangement, which avoids the aforesaid drawbacks inherent with a drying plant that includes separate dehumidifiers, high-pressure fans, hoses, etc.

Another object is to avoid the particular drawbacks associated with a method and an arrangement based on drying a water-affected area by the pressure method.

### SUMMARY OF THE INVENTION

These objects are fulfilled by a method according to the preamble of claim 1 and having the particular features set forth in the characterising clause of said claim.

Because the turbine is used both to force dry air to the water-damaged space and, alternatively, to suck moist air from such a space, and because the turbine is connected in the stated manner in both types of operation, one and the same turbine and drying arrangement can be readily used for both radically different types of operation.

When the drying plant is in place, the type of operation preferred can be determined on the basis of existing circumstances and the drying plant can be adapted to the chosen mode of operation by carrying out a few simple manual operations.

If a reason is found to switch to the other operational mode at a later stage, this can be achieved readily and quickly with the aid of earlier used major components, which can be readily supplemented in the manner necessary if so required.

One method of applying the invention is defined in claim 2.

The pipe used in this respect is an example of a device with which the turbine can work in order to facilitate switching between the different operational modes.

The effect of the applied suction method is further enhanced by delivering dry air to the building from the rotor of the drying plant. Some of the dry air delivered will be sucked into the water-damaged space, through the gap located between floor and wall.

The pressurised moist air sucked-in by the turbine can be led to the surroundings of the building via a pipe connected to the turbine outlet, this pipe also constituting an example of a given type of connecting means. The operation is suitably carried out via an outlet line connected to said pipe.

In one of the aforesaid operational modes, there may be provided upstream of the rotor, as seen in the flow direction a fan that sucks process air from the building and, after pressurising the air, delivers said air to the rotor.

Alternatively, the drying air may be pressurised by a fan positioned downstream of the rotor, prior to delivering said air to the building.

Part of the flow emanating from the fan in said alternative positions upstream and downstream of the rotor, as seen in the flow direction, can therewith be used to regenerate the rotor.

Another alternative is to use a separate fan for regeneration of the rotor.

In the alternative method of utilising the high-pressure turbine, namely to force dry air into the water-damaged area, dry air is passed from the rotor through a pipe to the turbine inlet, and air that is pressurised in the turbine is delivered to the water-damaged area through a further pipe connected to the turbine outlet.

It will be realised that said pipes constitute simple elements by means of which the drying plant can be switched effectively and readily between the two operational modes.

When applying the pressure mode, part of the dry air can be led to the building from the rotor through the medium of a separate pipe.

In an alternative application of the pressure method, the rotor outlet and the turbine inlet are interconnected by a valve-equipped conduit system, which includes a valve that can be set so as to cause the air to be delivered directly to the turbine inlet.

This enables dry air to be delivered also to the building via a fan connected to the conduit system and a branch line located downstream of the fan.

When the turbine is to be used to suck moist air from the water-damaged space, instead of utilising a conduit system of the aforedescribed kind, the supply of dry air to the turbine inlet is cut-off, for instance via a valve, and connected to a suction line from said space through the medium of a pipe.

The invention also relates to a drying plant for drying a water-damaged space, the essential features of the inventive plant being set forth in claim 13.

Further developments of such a drying plant are set forth in the dependent claims.

The invention will now be described in more detail with reference to a number of exemplifying embodiments and also with reference to the accompanying schematic drawings.

### BRIEF DESCRIPTION OF THE ACCOMPANYING SCHEMATIC DRAWINGS

FIG. 1 is a cross-sectional view of part of a water-damaged building of layered construction, equipped with an inventive drying plant that operates in accordance with the pressure method.

FIG. 2 is a cross-sectional view corresponding to that of FIG. 1, showing the drying plant operating in accordance with the suction method.

FIG. 3 is a cross-sectional view of an alternative embodiment of the drying plant in which rotor and turbine are mutually connected by a conduit-comprising valve system.

FIGS. 3a and 3b are views of valve arrangements with which the plant operates in accordance with the pressure method, while FIGS. 3c and 3d illustrate corresponding valve arrangements with which the plant operates in accordance with the suction method.

FIG. 4 is a cross-sectional view of a supplemented alternative of a conduit-system equipped drying plant corresponding to FIG. 3, where a fan is located downstream of the rotor.

FIGS. 4a and 4b illustrate relevant valve arrangements with which the plant of FIG. 4 operates in accordance with the suction method while FIGS. 4c and 4f show different valve arrangements with which the plant operates in accordance with the pressure method.

FIG. 5 is a cross-sectional view of a further alternative arrangement of the drying plant with which a pipe belonging to the turbine has a rotatable valve which enables the turbine to be readily switched between respective pressure and suction modes.

FIG. 6 illustrates part of the valve arrangement according to FIG. 5 in another state, and shows said arrangement in larger scale for the sake of clarity.

FIGS. 7 and 8 illustrate valve arrangements with which a typical three-way valve is used instead of a rotatable valve for corresponding purposes, wherein FIG. 7 shows the valve arrangement when the turbine operates in accordance with the pressure method and FIG. 8 shows the valve arrangement when said turbine operates in accordance with the suction method.

### DESCRIPTION OF PREFERRED EMBODIMENTS

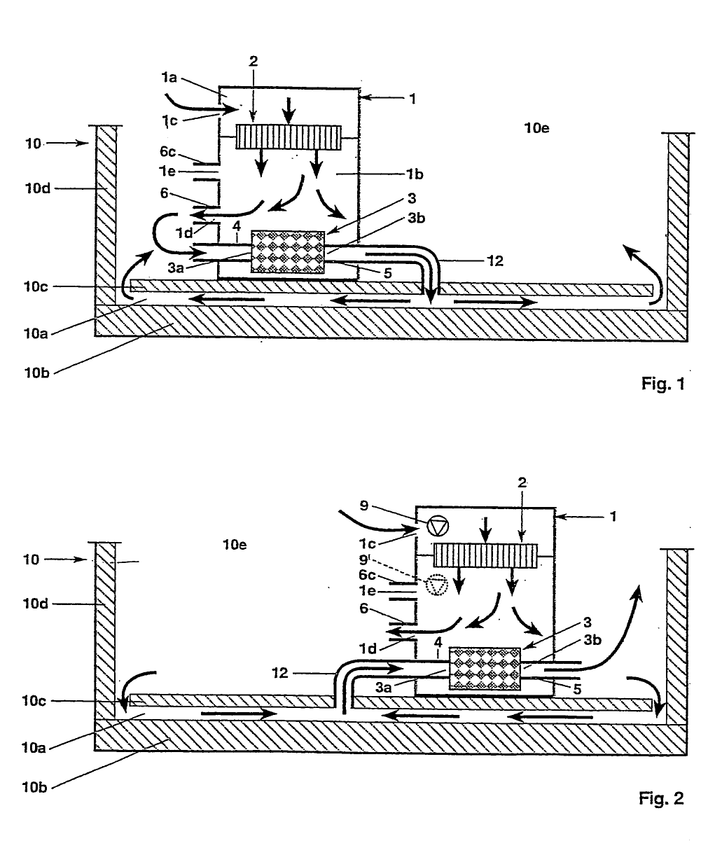

FIGS. 1 and 2 illustrate a layered building construction 10, which is comprised of structural concrete and provided with an insulating floor 10c spaced from the concrete floor 10b.

Located between the floor 10c and the wall 10d is a gap, meaning that the floor terminates short of the wall.

One disadvantage with this type of construction is that in the event of water damage, the water present on the floor will run down into the gap adjacent the wall and from there onto the insulation 10a, in other words the space between the concrete 10b and the floor 10c will be filled successively with water.

In order to alleviate such water damage, drying plant 1 has been placed on the insulated floor 10c.

This plant comprises a housing or casing 1a, which accommodates in its upper part a regeneratable drying rotor 2 and in its lower part a high-pressure turbine or some appropriate fan 3. The plant is able to function in accordance with two principally different methods, namely the pressure method illustrated in FIG. 1, and the suction method illustrated in FIG. 2.

In the case of the first mentioned method, the turbine 3 forces dry air from the rotor 2 into the water-damaged space 10a In the case of the method illustrated in FIG. 2, the turbine 3 sucks moist air from the space 10a instead, this moist air being delivered to the external surroundings of the building. The high-pressure turbine 3 co-acts with means that enable the plant to be readily switched between these two operational modes.

FIG. 1 illustrates how dry air departs from the inner space 10e of the building 10 via a lower chamber 1b and an opening 1d in the wall of the casing 1a, and how said dry air is sucked into the turbine via a pipe 4 connected to the turbine inlet 3a and, after being pressurised in the turbine, is delivered under pressure to the water-damaged space 10a via a pipe 5 connected to the turbine outlet 3b. One requirement in this respect is the provision of a fan 9 or 9′ shown in FIG. 2.

As the air from the rotor 2 passes the chamber 1b, it is able to pass in the vicinity of the electric motor (not shown) of the turbine and therewith be heated still further.

If so desired, the opening 1d of the housing 1a can be connected to the turbine inlet pipe 4 by means of a conduit, in which case no heated air will be delivered to the interior space 10e of the building.

As a further alternative, the heated air coming from the rotor 2 never leaves the interior space 1b of the drying plant, but is passed directly to the inlet pipe 4 of the turbine 3 after having circulated around the region of the turbine motor in the aforesaid manner.

When the drying plant 1 shown in FIG. 2 operates instead in accordance with the suction method, the pipe 4 connected to the turbine inlet 3a is coupled to the line or conduit 12 that opens into the space 10a, so that moisture is sucked from the space by the turbine and departs to the building or to the external surroundings of the building, via a line or conduit (not shown) through the medium of the pipe 5 connected to the outlet 3b.

In both of the different operational modes shown in FIGS. 1 and 2 respectively, dry air is delivered from the rotor 2 to the interior 10e of the building 10, via the opening 1d in the casing 1a.

A fan that sucks air from the building interior and delivers said air to the rotor 2 subsequent to pressurising the air is not found in the embodiment illustrated in FIG. 1. The embodiment illustrated in FIG. 2 includes such a fan, referenced 9, which may, of course, also operate in the pressure method-illustrated in FIG. 1.

Alternatively, the fan 9 shown in FIG. 2 can be replaced with a fan 9′ arranged downstream of the rotor 2 and functioning to suck air from the building through the rotor 2.

If desired, part of the flow from one of the fans 9, 9′ can be used to regenerate the rotor 2. Alternatively, a separate fan can be used to this end.

When applying the suction method, it is normally necessary to provide a fan 9 or a fan 9′ that operates upstream or downstream of the rotor 2.

If dry air shall also be delivered to the building interior 10e, regardless of the operational mode, a separate pipe 6c having an outlet opening 1c should be connected to the opening 1c in the casing 1a of the drying plant.

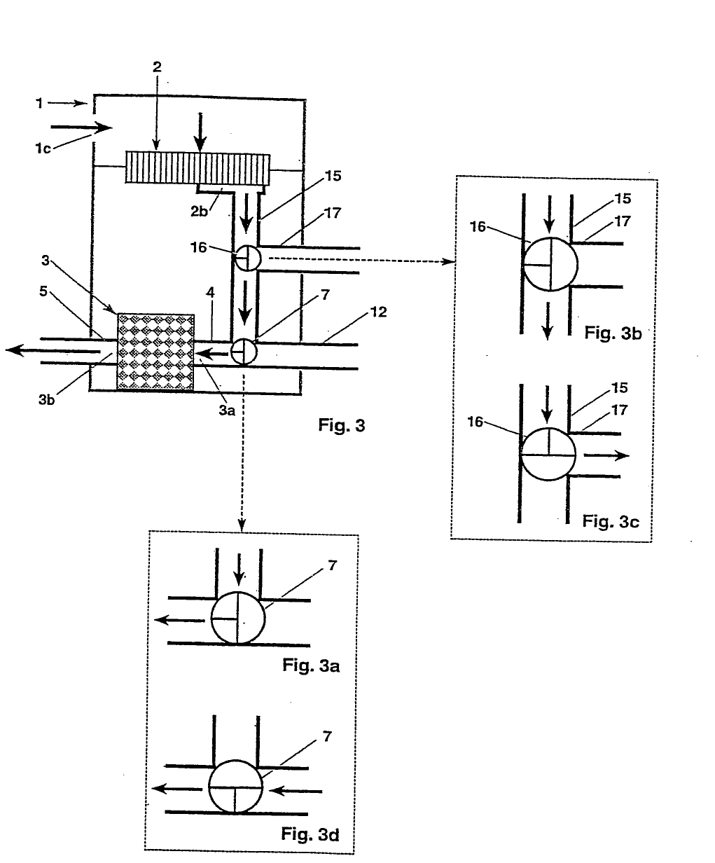

FIG. 3 is a schematic illustration of an alternative embodiment of the drying plant, in which the rotor outlet 2b and the turbine inlet pipe 4 are connected by a valve-equipped conduit system where the lower part of the vertically directed conduit 15 is connected to the turbine inlet pipe 4 (the turbine 3 has been turned through 180 degrees in relation to FIGS. 1 and 2) via a valve 7. As will be seen from the figure, when the turbine is used to press dry air from the rotor 3 the valve 7 is set so that the air will be delivered directly to the turbine inlet 3a.

Because the turbine 3 sucks dry air from the rotor 2, no additional fan is required in the conduit system.

However, if it is desired to constantly deliver dry air to the room or space, a fan (not shown) can be provided in the conduit system 15 downstream of the rotor 2, and the valve 16 in the conduit 15 of the FIG. 3 embodiment omitted. Dry air will then depart to said room or space via the branch line 17′.

The drying plant illustrated in FIG. 3 and the associated valve arrangements shown in FIGS. 3a and 3b are set to work in accordance with the pressure method, wherewith (as before mentioned) the valve 16 is dispensed with or given the illustrated setting, whereby the dry air from the rotor 2 will be delivered to the suction side of the turbine via the valve 7.

The valve arrangements or settings according to FIGS. 3c and 3d are, instead, relevant when the drying plant shall operate in accordance with the suction method, wherewith (c.f. FIG. 2) the inlet pipe 4 is connected to a conduit 12 that serves as a suction conduit, and the valve 7 has the setting shown in FIG. 3d. Warm air from the rotor 2 can therewith be conducted to the room or space via the valve 16 and the branch line 17, when the valve 16 has the setting shown in FIG. 3c.

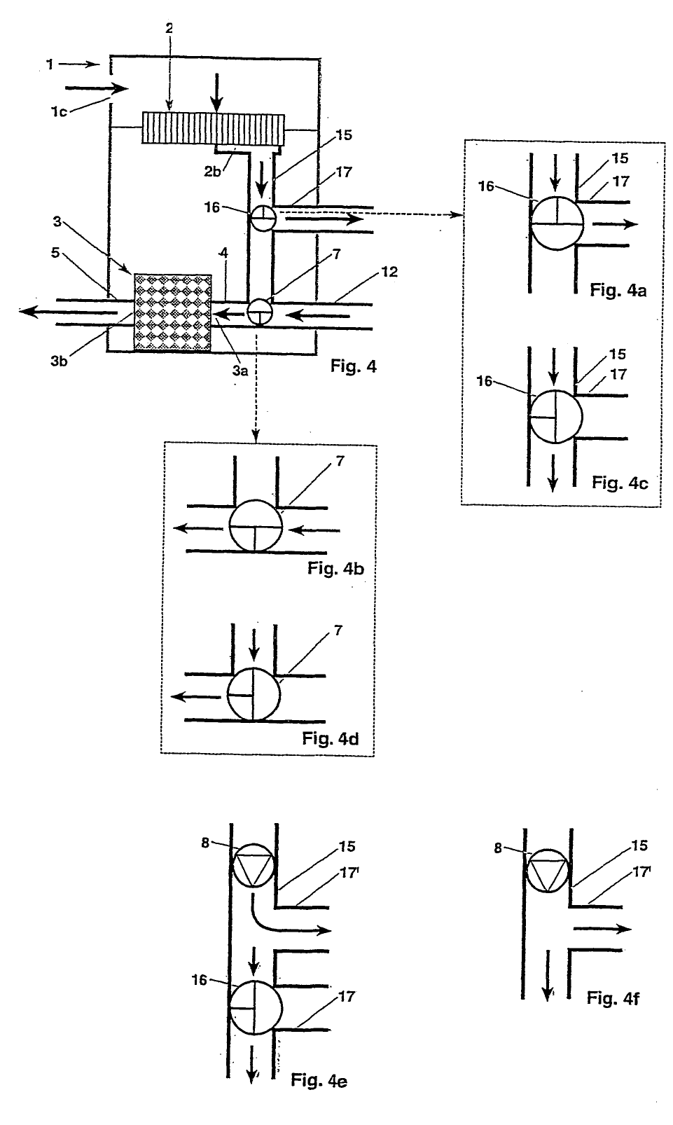

The drying plant illustrated in FIG. 4 and the associated valve arrangements or settings shown in FIGS. 4a-4f are intended to further illustrate the aforesaid conditions.

The valve illustrations in FIGS. 4a and 4b show the settings of respective valves 16 and 7 when the drying plant 1 operates in accordance with the suction method, while the remaining FIGS. 4c-4f illustrate valve settings when operating in accordance with the pressure method.

In this regard, no fan is required owing to the fact that the turbine sucks dry air directly from the rotor 3. However, should it be required to deliver further dry air to the room or space, a fan may be provided in addition to the illustrated branch line 17.

FIGS. 4e and 4f—which both indicate the presence of a fan 8 in the conduit—show that additional dry air departs to the room or space via the conduit 17′, even in the absence of the valve 16. Dry air is sucked into the turbine 3 in all of the embodiments that operate in accordance with the pressure method.

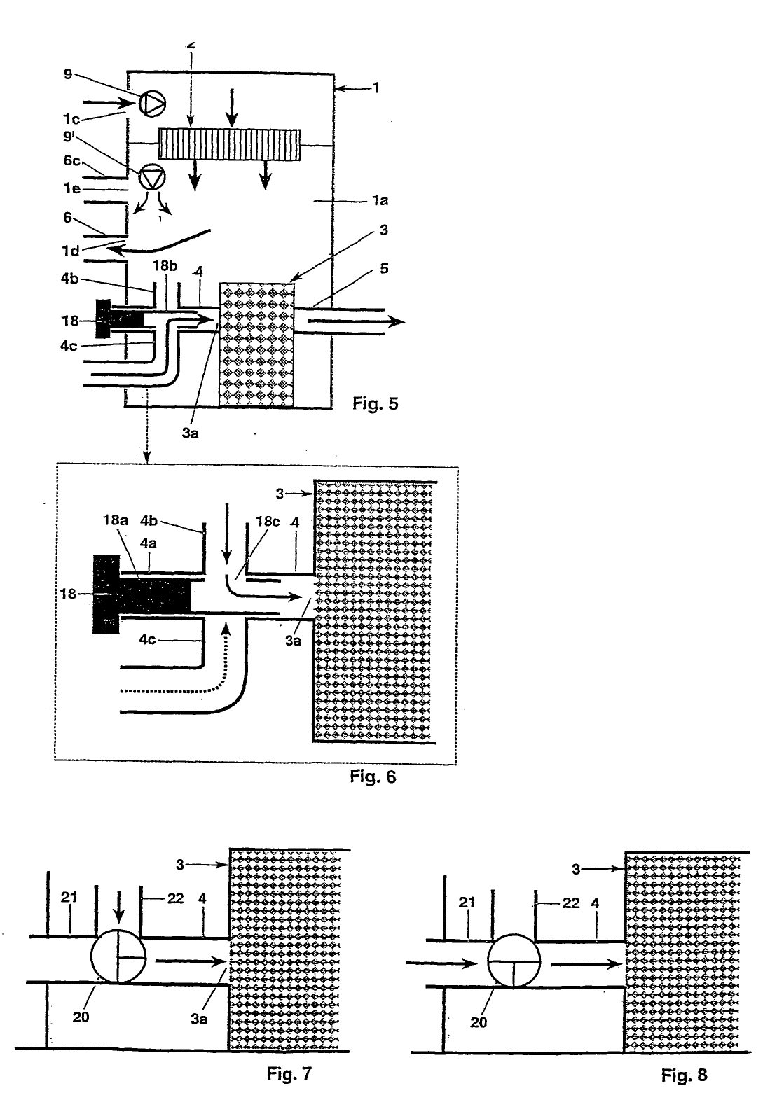

FIGS. 5 and 6 illustrate schematically the principle of a further alternative embodiment of the drying plant 1. The figures illustrate the suction and pressurisation of air from the room or space 10e via a fan 9 located upstream of the rotor 2 and delivering dry air to said room or space via the pipe 6 connected to the opening 1b. Connected to the turbine inlet opening 3a is a main pipe 4 which, in turn, includes two oppositely directed branch pipes 4b and 4c respectively. Provided in the outer end 4a of the pipe 4 is a rotatable valve means 18 which includes a body part 18a and a tubular part 18b that includes a peripheral hole 18c. The hole 18c can be caused to register with either one of the two branch pipes 4b and 4c, by appropriate rotation of the valve means 18.

When the branch pipe 4c is open—shown in FIG. 5—the drying plant is intended to operate in accordance with the suction method. In the alternative valve setting—shown in FIG. 6—in which the branch pipe 4b is open, the drying plant is intended to operate in accordance with the pressure method, wherewith dry air from the rotor is delivered to the turbine inlet 3a.

In accordance with the aforegoing, settings shall be made on the turbine inlet side or the turbine suction side.

This enables the drying plant to be switched between both of its alternative operational modes in a simple manner.

FIGS. 7 and 8 are intended to show that the rotatable valve 18 in FIGS. 5 and 6 can be replaced with a three-way valve 20, wherein the valve setting illustrated in FIG. 7 is intended for operation in accordance with the pressure method, while the valve setting illustrated in FIG. 8 corresponds to functioning of the drying plant 1 in accordance with the suction method.

As shown, the three-way valve 20 is included in two conduits 21, 22, which are connected to the turbine inlet pipe 4 in the vicinity of the valve 20.

In order to facilitate switching between the two operational modes, the conduit 12 may consist of a flexible hose, which carries at its ends bayonet fittings for alternative connections to the pipe 6 and the space 10a. The end of the conduit that is intended for insertion into the space 10a for suction purposes may be provided with a filter or a sieve.

It will be understood that the invention can also be applied in ways other than those described and lying within the scope of the accompanying claims.

1. A method for drying a water-damaged building with the aid of drying plant that includes a drying rotor or some other means for delivering dry air to the drying process, and a high-pressure turbine or some appropriate type of fan for air transportation, characterised by using one and the same turbine or fan for pressing dry air into a water-damaged space in the building or, alternatively, for sucking moist air from such a space; and by connecting the suction or pressure side of the turbine in respective operational modes to a conduit leading to said space, through the medium of connecting means.

2. A method according to claim 1, characterised in that when the turbine is in a suction mode there is connected, via a pipe, a suction line which connects the turbine inlet with the space while dry air from the rotor is delivered to the building; and in that moist air sucked from the space and pressurized by said turbine is passed to the building or to its external surroundings through the medium of a pipe connected to the turbine outlet.

3. A method according to claim 1, characterised in that process air is sucked from the building by means of a fan and delivered to the rotor subsequent to pressurization.

4. A method according to claim 1, characterised in that the dry air is pressurised pressurized by a fan located downstream of the rotor, prior to delivering said air to the building.

5. A method according to claim 3, characterised by using part of the air flow from the fan to regenerate the rotor.

6. A method according to claim 3, characterised by using a separate fan for rotor regeneration.

7. A method according to claim 1, characterised in that when the turbine presses dry air into the water-damaged space, dry air from the rotor is passed to the turbine inlet via a pipe, wherein air pressurized by the turbine is delivered from its outlet to the water-damaged space via a further pipe.

8. A method according to claim 1, characterised by passing a part of the dry air from the rotor to the building.

9. A method according to claim 7, characterised by connecting the outlet of the rotor and the inlet pipe of the turbine through the medium of a valve-equipped conduit system; and by setting a valve so that dry air will be delivered directly to the turbine inlet.

10. A method according to claim 9, characterised by also delivering dry air to the building through the medium of a fan in connection with said conduit system and a branch line located downstream of said fan.

11. A method according to claim 1, characterised by mutually connecting the rotor outlet and the turbine inlet through the medium of a valve-equipped conduit system; and by cutting-off the supply of dry air to the turbine inlet when the turbine is used to suck moist air from the water-damaged space, wherein said turbine inlet is connected to a suction conduit from said space via a pipe.

12. A method according to claim 11, characterised in that switching between operational modes is effected with the aid of a rotatable valve element mounted in said pipe.

13. Drying plant for drying a water-damaged space in a building, comprising
a) a housing or casing which houses a drying rotor or some other device that emits dry air, and a high-pressure turbine or an appropriate type of fan for air transportation; and
b) inlet and outlet openings to and from the housing respectively, characterised in that
the turbine is adapted for pressing dry air into the water-damaged space and, alternatively, to suck moist air from said space; and in that the turbine co-acts with means for facilitating switching between these two operational modes.

14. Drying plant according to claim 13, characterised in that said means include pipes that can be connected to the turbine inlet and outlet, and also conduits that are or can be connected to said pipes.

15. Drying plant according to claim 14, characterised in that the pipes or the conduits are equipped with valves.

16. Drying plant according to claim 15, characterised in that at least one of said valves is a rotatable valve.

17. Drying plant according to claim 15, characterised in that at least one of the valves is a three-way valve.

18. Drying plant according to claim 14, characterised by a fan that pressurizes dry air delivered to the turbine from the rotor via a conduit.

19. Drying plant according to claim 14, characterised in that one of the conduits has the form of a flexible hose which carries at its ends respective bayonet fittings, and which has a detachable filter or sieve on at least one end.
